(19) United States
(12) Patent Application Publication
(10) Pub. No.: US 2002/0143636 A1
(43) Pub. Date: Oct. 3, 2002

(54) Advertising aided purchasing system

(75) Inventor: Andrea Carignani, Milan (IT)

Correspondence Address: SHEARMAN & STERLING, INTELLECTUAL PROPERTY DOCKETING, 599 LEXINGTON AVENUE, NEW YORK, NY, 10022, US

(73) Assignee: Madai S.r.L.

(21) Appl. No.: 09/775,221

(22) Filed: Feb. 1, 2001

(51) Int. Cl. G06F 17/60

(52) U.S. Cl. 705/26

(57) ABSTRACT

A system for reducing a purchase price of a selected product or service by obtaining revenue from advertisements displayed in conjunction with a product or service offered for sale and applying a predetermined amount of that revenue toward the purchase price in order to incrementally reduce the purchase price of the selected product or service based upon the number of advertisements viewed.

### BACKGROUND

The invention relates to an arrangement for electronic shopping.

### SUMMARY

In general, in a first aspect, the invention features displaying a product for sale at a predetermined purchase price, and an advertisement for a product, where the seller of the advertised product pays an advertising fee to a party offering the product and if the product is not accepted, offering the product for sale at a price reduced by a portion of the advertising fee.

In general, in a second aspect, the invention features displaying a selected product for sale at a predetermined purchase price to a plurality of users, displaying an advertisement for a product or service on a page with the selected product to the plurality of users, decreasing the predetermined purchase price for the selected product by a predetermined reduction amount to a decreased purchase price, where the predetermined reduction amount is dependent upon a number of impressions of the advertisement viewed by the plurality of users.

In some embodiments, the invention may include one or more of the following features, such as reducing the purchase price by a predetermined amount based upon an amount of advertising banners viewed by at least one of the plurality of users, determining the amount of advertising banners viewed by at least one of the plurality of users, and/or displaying the decreased purchase price to the plurality of users.

In some embodiments, the invention may also include one or more of the following features, such as storing the decreased purchase price in a database, locating the advertisement banner for an unrelated product in a database that stores available advertisement banners determining whether each one of the plurality of users are registered users, and/or where an individual one of the plurality of users is determined to be a registered user, allowing the registered user to purchase the selected product at the decreased purchase price.

In general, in a third aspect, the invention may feature a method of selling a product at a reduced purchase price via an electronically connected network, such as the Internet, where the method may include displaying at least one individual product for sale on a vendor web page accessed by at least one of a plurality of users via the Internet, the web page having at least one advertising banner for which the vendor receives an advertising fee, determining a cumulative amount of impressions of the advertising banner viewed by at least one of the plurality of users, and reducing the purchase price of the at least one individual product or service by a portion of the advertising fee received, where the advertising fee is determined from the amount of advertisements viewed.

In some embodiments, invention may include the advertising fee being determined from the cumulative amount of impressions viewed by at least one user, locating the advertisement banner for the unrelated product in a database that stores available advertisement banners and/or selecting an available advertisement banner customized for at least one user.

In some embodiments, the invention may include one or more of the following features, such as storing the decreased price in a database, displaying the decreased price to the at least one user, displaying a plurality of offers for sale of multiple products or services displayed on the web page, and/or setting a minimum price below which the predetermined price cannot be reduced.

In some embodiments the invention may include reducing the predetermined price of the offered products at a variable rate per impressions of the advertisement banner viewed.

In general, in a fourth aspect, the invention features a computer programmed to reduce a purchase price of a product offered for sale and displayed on a web page displaying an advertisement by a predetermined amount dependent upon a number of advertisements viewed by at least one user.

In some embodiments the invention may include the predetermined amount being determined at least in part on an original purchase price, an agreed upon formula in a contract governing fees for the advertisement and local law.

In general, in a fifth aspect, the invention features method which may include displaying a first offer for sale of a product at an first purchase price and at least one advertisement, determining a number of advertisements viewed by at least one user, generating real time revenue from the advertisement being viewed, applying a portion of the real time revenue towards the first purchase price of the product, and displaying a second offer for sale of the product at a second purchase price, the second purchase price being lower than the first purchase price.

In general, in a sixth aspect, the invention features a method for purchasing products via and with the support of a network accessed by at least one user, where the method may include accessing a web page displaying at least one product offered for sale and at least one advertisement, where the price of the product offered for sale is reduced by an amount proportional to an amount of advertisements viewed by the at least one user and purchasing the product offered for sale from the web page at a price reduced by a predetermined amount based upon the amount of advertisements viewed.

The above advantages and features are of representative embodiments only, and are presented only to assist in understanding the invention. It should be understood that they are not to be considered limitations on the invention as defined by the claims, or limitations on equivalents to the claims. Additional features and advantages of the invention will become apparent in the following description, from the drawings, and from the claims.

### DESCRIPTION OF THE DRAWING

FIG. 1A is a schematic drawing of a database structure;

FIG. 1B is an entity relationship diagram;

FIG. 2 is a schematic drawing of the database structure according to FIG. 1 interconnected to the Internet and a datawarehouse;

FIG. 3 is a flow chart;

FIG. 4 is another flow chart;

FIG. 5 is a schematic diagram of a database and web procedures and controlled content on various web pages;

FIG. 6 is an additional flow chart;

FIG. 7 is another flow chart; and

FIG. 8 is another flow chart.

### DESCRIPTION

A web site offers one or more products or services for sale to users. It is to be understood that a reference to products includes, but is not limited to, products or services. As each user views the site, one or more advertisements are displayed. The advertiser pays the web site operator, or vendor, a fee for displaying the advertisement. The user may purchase one of the products at a current price. If the user does not purchase the product, the vendor may apply a part of the advertising fee to reduce the price of one or more of the products at which the product will be offered subsequent to a user viewing the advertisement. The remainder of the advertising fee may be retained by the vendor, for example, as profit. If the user purchases the product, the product will be sold to the user and a new product may be substituted for the next user to view on the page. The substituted product may be initially offered at the market price.

Real time advertising revenue may be generated where a portion of that revenue may be applied to the purchase price of a selected product thereby decreasing the purchase price of the selected product for the consumer. At least one database and a computer may be programmed to determine a number of users viewing advertisements having at least one pre-selected product at a predetermined purchase price offered for sale. The computer may also be programmed to selectively lower the available purchase price of the pre-selected product depending upon a predetermined value set for a predetermined amount of advertisements viewed.

It will be understood that advertisement can include an advertisement banner displayed on a web page also displaying products or services for sale. Additionally, it will be understood that the present system may encompass advertisement spots or short movies, short message services messages (or SMS), advertisement email messages, audio messages sent to voicemail, and text messages sent to a pager or other device applying wireless mobile technology. Further, it will be understood that the system can include any advertisement message that may be transmitted electronically via telematic channels. The system can be applied to any communication channel including, but not limited, to the Internet, telematic transmission and interactive television.

In some embodiments the purchasing system may be an Internet based system having a web page displaying multiple individual products for sale along with multiple advertising banners. A user may select an individual particular product for example, by clicking on a picture or an icon that represents the product that is displayed on a homepage. Once the user clicks on the product's icon the system may direct the user to a web page specifically designed around the selected product, known as a product page. In such an example, the product page may include icons to allow the user to select information regarding, for example, different brands, price ranges, types (flat screen televisions, conventional CRT televisions, etc.), and thereafter review the products available relating to the particular selection in a manner much similar to reviewing a printed product catalogue.

The individual product page may include various technical data about the selected product, an original purchase price, a reduced purchase price, and multiple advertising banners. The purchase price of the selected product may be reduced by a predetermined amount per advertisement banner viewed by all users. As more users view the selected product, the purchase price may be reduced by a predetermined amount until the selected product is purchased or an absolute minimum purchase price is reached, at which point no further reduction in the purchase price may occur.

The predetermined reduction in purchase price may be dependent upon the selected product, the original purchase price, the available advertising banner placed on the product page and various other factors.

### Architecture

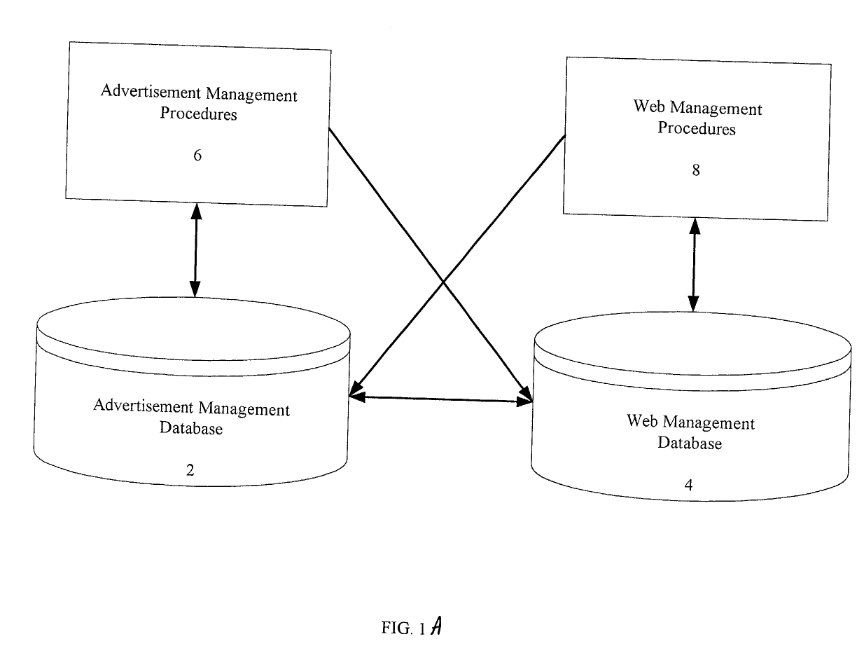

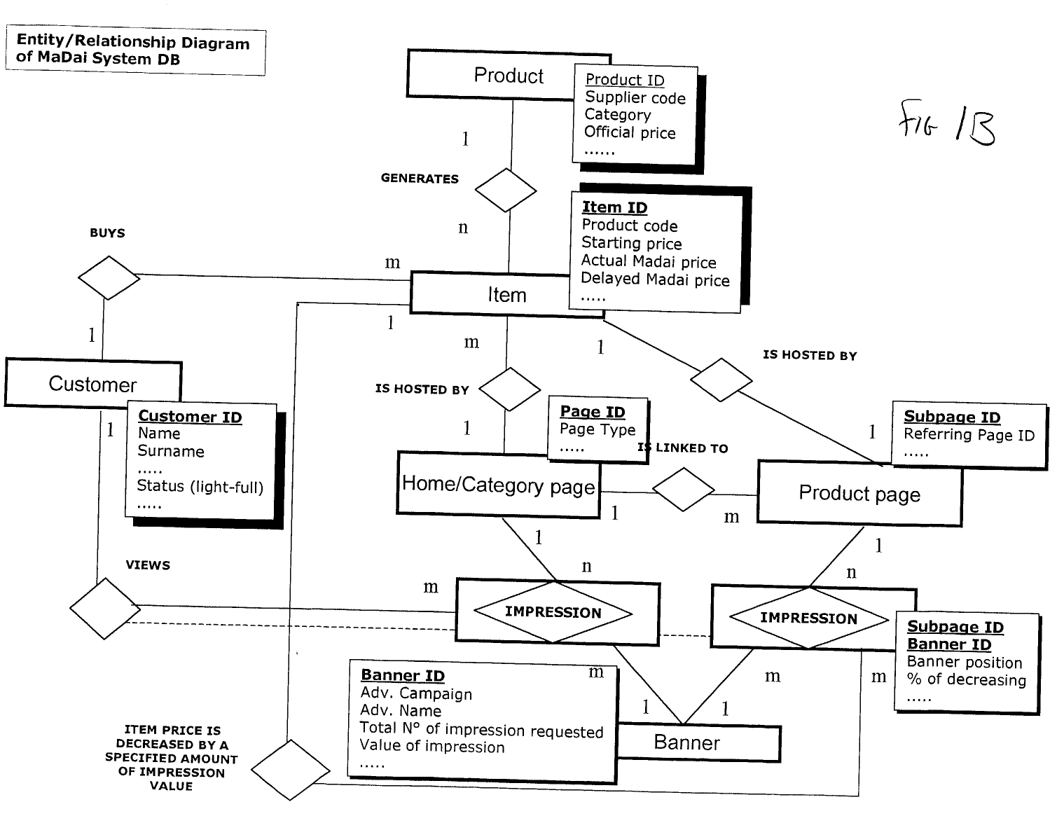

Referring to FIG. 1A, a banner management database 2 and a web management database 4 may be in communication with each other. Banner management procedures 6 may be in communication with both databases 2 and 4, and web management procedures 8. Alternatively, databases 2 and 4 may be integrated with management procedures 6 and 8.

In FIG. 1B an entity relationship diagram can be seen. Various entity relationships can be implemented as defined in FIG. 1B, such as Product ID, Item, ID, Banner ID, and Subpage ID. An exemplary entity relationship schedule is listed in Table 1 below.

TABLE 1
Entity Relationships

| | |
|---|---|
| I. | Product ID = number defined by Vendor |
| | Supplier = code number defined by Vendor |
| | Category = string defined by Vendor |
| | Official price = average market product price |
| II. | Item ID = number defined by the system |
| | Product code = Vendor assigned identification of product |
| | Starting price = Vendor starting selling item price |
| | Actual Vendor price = Real time Vendor item price |
| | Delayed Vendor price = Time delay selected item price |
| III. | Banner ID = Alphabetical string defined by the system for each new banner added |
| | Adv. Campaign = Number defined by Vendor for distinguish AD Campaign promoted by |
| | the same advertiser |
| | Advertising Name = Alphabetical string |
| | Total N^{o} of impression requested = Number of impression bought (by the advertiser) on |
| | that specific banner |
| | Value of impression = Price Vendor paid for each impression |
| IV. | Subpage ID = Number, or integer |
| | Banner ID = Alphabetical string |
| | Banner position = Alphabetical string (two value are possible, “top_banner” |
| | “right_banner”) |
| | Percentage of decrease = Number assigned to decrease amount of price |

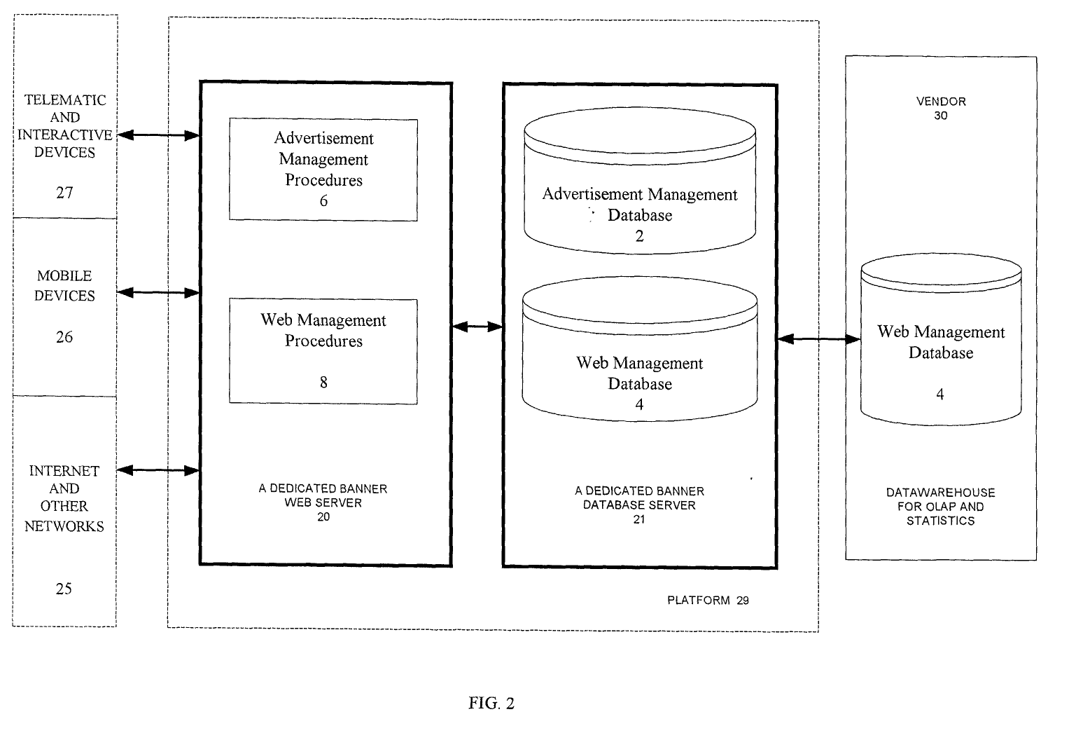

Referring now to FIG. 2, banner management procedures 6 and 8 may be located on a single server 20 dedicated for web banners. Server 20 may be an application server that may contain multiple types of procedures where procedures 6 are related to banner management, and procedures 8 are related to web management, such as for the creation of the web pages, product pages and the like. Server 20 may be physically connected via a private network or another database server such as to server 21, where server 21 may be a database server that may contain multiple databases. Banner management database 2 and web management database 4 may be located on single database server 21. Servers 20 and 21 may be in direct communication with each other and may be located in a single platform 29.

A vendor 30, which may operate and support web pages 42, 45, 46, etc. (discussed in further detail below), may have a web management warehouse 7 located in an onsite computer data warehouse (not shown). At Box 25, users may access the purchasing system through portals via the Internet, such as web browsers, mobile devices 26, telematic and interactive channels 27, and the like. The Internet (Box 25) may be electronically connected directly to platform 29 that contains servers 20 and 21.

Data warehouse 7 may include a combination between data contained in database 2 and database 4. Warehouse 7 may be mined for information using On-Line Analytical Processing (OLAP), which may be used for exploring historical based databases and providing a real time analysis of data.

### User Flow

A user may access the system via an on-line provider such as AOL,™ CompuServe,™ WebTV,™ etc. In some embodiments the user can access the system via direct access to the Internet 25, by using an Internet browser such as Netscape.™ Upon gaining an access to the Internet 25, the system may proceed to a user homepage 45. Depending on the user's choice, from the homepage 45, the system may proceed to light registration homepage 52, full registration homepage 54, product homepage 105 or category page 107. Alternatively the user may choose to exit the system by selecting another URL address.

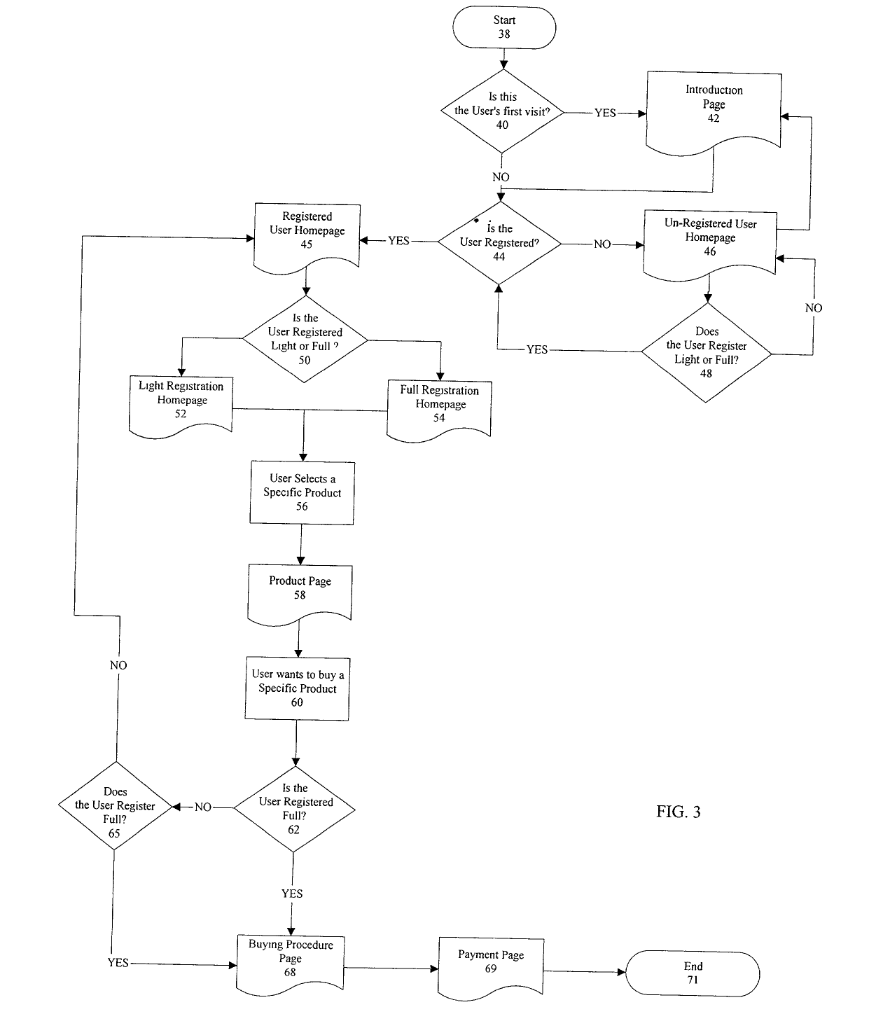

Referring now to FIG. 3, a user browsing the Internet 25 may access a web page of system at step 38. It will be understood that, in conjunction with various embodiments as indicated above, a user can access the system through web browsers, TCP/IP based software, or intranet proprietary software for data interchanges in client-servers and wireless application protocols. Step 40 may determine whether the user is a first time visitor. If the user is a first time user then the user may be directed to an introduction page (step 42). The introduction page (step 42) may include informational web page links, company contact web pages and a mock sale may be executed for explanation purposes. In some embodiments, the introduction page may be a separate pop-up window allowing the user to view introduction material continuing to browse the system. Step 44 may determine whether the user is registered with vendor 30. If not, in step 46, the user may be directed to a web page designed for unregistered users that may detail the advantages of becoming a registered user. In step 48, the user may then be presented with the option of becoming a registered user.

It should be noted that in the preferred embodiment of the disclosed invention, the user may back-track from any particular point in the system. Notably, the user is able to return to the homepages 45, 52, 54, 105 or 107 from any part of the system. This being stated generally, it will be appreciated that this feature is applicable to the further system steps described below and, therefore, it will not be repeated in the following description.

The user may register with vendor 30 by filling out an information collecting form that may include items such as name, address, phone number, email address and the like. There may be multiple levels of registration, with superior levels (discussed below) providing increased benefits and advantages to the user in return for more demographic and financial information. This information may be analyzed by vendor 30 in order to determine the types of products and advertisements that best fit a particular user's personal tastes or purchasing habits.

A user may register for a light registration 52 or a full registration 54. The registration process may include some form of user identifying marker being placed on the hard drive of the user's computer, such as a cookie. This allows the system to easily identify previous visitors and registered users. The registration may also include a security feature by which the user may select a user ID and a corresponding password in order to gain access to the secure areas in the purchasing system.

For a light registration, the user may provide preliminary information such as name and email address. For a full registration, the user may provide purchasing and product delivery information such as, credit card information, billing address, delivery address and a secure purchasing password in order to provide high level security to the user's personal information. The user may be instructed during his or her browsing session as to the current level of registration. In some embodiments, users may browse at a light registration level until he or she decides to purchase a product, at which point full registration may be obtained in order to complete the transaction.

Once registered either light or full, the user may be directed to a general homepage designed for registered users 45, which may display information on various products available for purchase and select information regarding current discounts. In some embodiments the user may browse the purchasing system without first logging in. In this case the user may be prompted to log in to the purchasing system so the user may be recognized and his or her personal information may be applied to any desired purchases. In the case of a user accessing the purchasing system via a location other than his or her computer, the user may optionally employ the user ED and password combination to gain access thereto. In a preferred embodiment a user will have access to more price reduction information at step 45 than step 46. This may incentivize a user to register before browsing the system and hence make product purchasing more efficient.

Once the user has registered and/or logged in to the purchasing system, the user may be directed to either the light registration homepage 52 or the full registration homepage 54. At homepage 52, 54 the user may be provided with information relating to products that are available for purchase and the discounts applied thereto. In step 56, the user may select a specific product. In step 58, the user may be directed to a page specifically describing the selected product. Information displayed about the selected product may include original purchase price, discount percentage and current purchase price. In addition, the user may also see multiple advertisement banners on the selected product page, which may affect the final purchase price of the selected product.

If the user wishes to purchase the selected product (step 60) the system may determine whether the user is registered light or full (step 62). If the user is not registered full, the system may query the user about registering full (step 65). If the user does not wish to register full then the user may be directed back to the general homepage for registered users 45, or in the alternative, user may exit the system.

If the user is registered full, the system may direct the user to a buying procedure page (step 68), which may include standard forms for inputting payment information, a user ID and password (step 69), additional delivery information, etc. In other embodiments, users may be provided access to all web pages, including product pages, purchasing pages and payment pages before registration or login is required.

If the user has entered the Internet via an on-line provider (not shown), his or her credit card account number may be obtained on-line from the on-line provider. Therefore, rather than prompting the user to enter his or her credit card account number or a program account number provided by the on-line provider, the credit card account number can be obtained on-line from the on-line provider or the account can be matched against accounts that may have been saved in web database 4 from previous visits. If a match is obtained, the program account number can be read from database 4. However, for security purposes, it is preferable that the system will not proceed to buying page (step 68) to display the account information before the user has been prompted and has entered at least the correct userID and password.

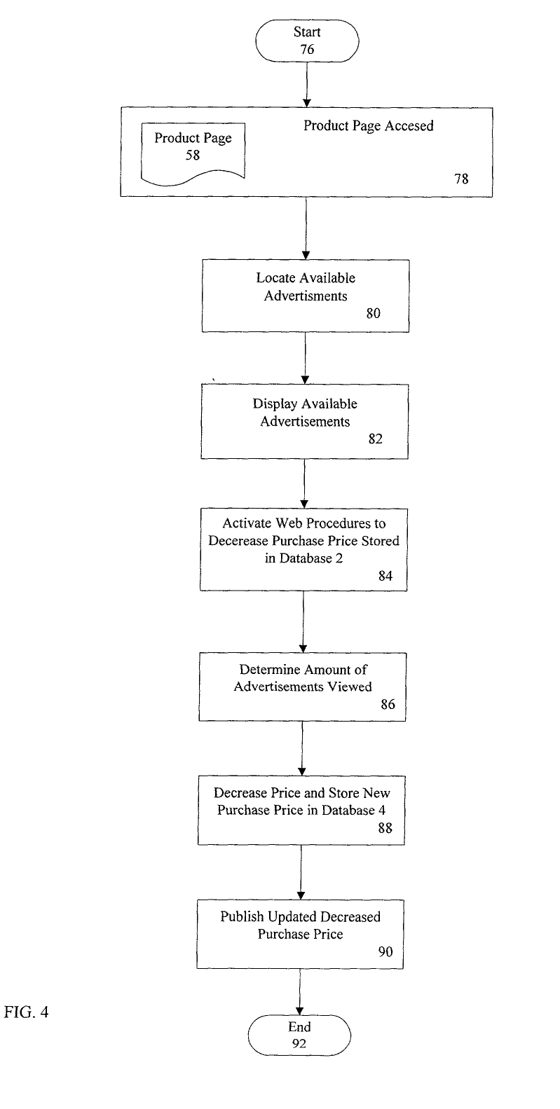

Referring now to FIG. 4, a user may access the system at step 76, which may be at any point in the system as discussed above, and may be provided access (step 78) directed to a specific product page (step 58). Available ad banner (step 80) for the product page may then be located. Criteria may be consulted to determine appropriate advertisement banners for a particular user based upon a variety of demographic and purchasing factors attributed to the user. The purchasing system may select advertisement banners targeted for particular users based on information obtained from user information and/or click-through tracking systems. For example, if the user is a male between the ages of 25-35 and has previously viewed and/or purchased audio equipment, available advertisement banners may be located which are best suited to this user, such as an advertisement banner for a DVD player.

An advertisement 82 may then be displayed on product page 58. As each impression of the advertisement is viewed the purchase price of the selected product 84 may be decreased and the new purchase price may be stored in database 2. The amount of all impressions of the advertisement viewed by all users on the selected product page 86 may be determined, the price may then be decreased and the new purchase price 88 may be stored in database 4. After the new price is stored the purchase price may be updated and published on the web page.

Each time a particular impression of an advertisement is viewed the purchase price of the selected product may be reduced by a predetermined amount. The amount of the reduction may be dependent upon many factors including the particular product, starting purchase price, the amount of times a particular user has viewed the product page, the agreement with the advertiser, and in some cases local law.

In some embodiments a distinction is made between a light registered user and a full registered user in that the purchase price of the selected product stops going down only when a full registered user decides to purchase the product. In the case of our exemplary user, if the user has only registered light, the user may not purchase the selected product unless and until full registration is completed. More importantly, in some embodiments the user may not prevent the selected product from being sold to another user as the selected product may not be removed from the system during the time the light registered user is completing the full registration process. Therefore, during the period that the user is completing the full registration process, i.e. providing delivery address, credit card information and the like, the price of the product may continue to be reduced by a predetermined amount per impressions of the advertisement banner viewed.

If the user is registered full the selected product may be removed from the system while the full registered user completes the buying procedure. In some embodiments the user will have a predetermined amount of time to complete the purchasing transaction of the selected product. If the user does not complete the transaction within the predetermined time period the product may be placed back on the system and made available for purchase by other users. In some embodiments the selected product may be placed back onto the product page at the original purchase price or at the price reflecting the moment the product was removed therefrom by the user's selection. In some embodiments, the purchase price of a selected product may be viewed in real time only by full registered users. In some embodiments, light registered users may only see the purchase price in a time delay, for example, twenty minutes.

### Product Flow

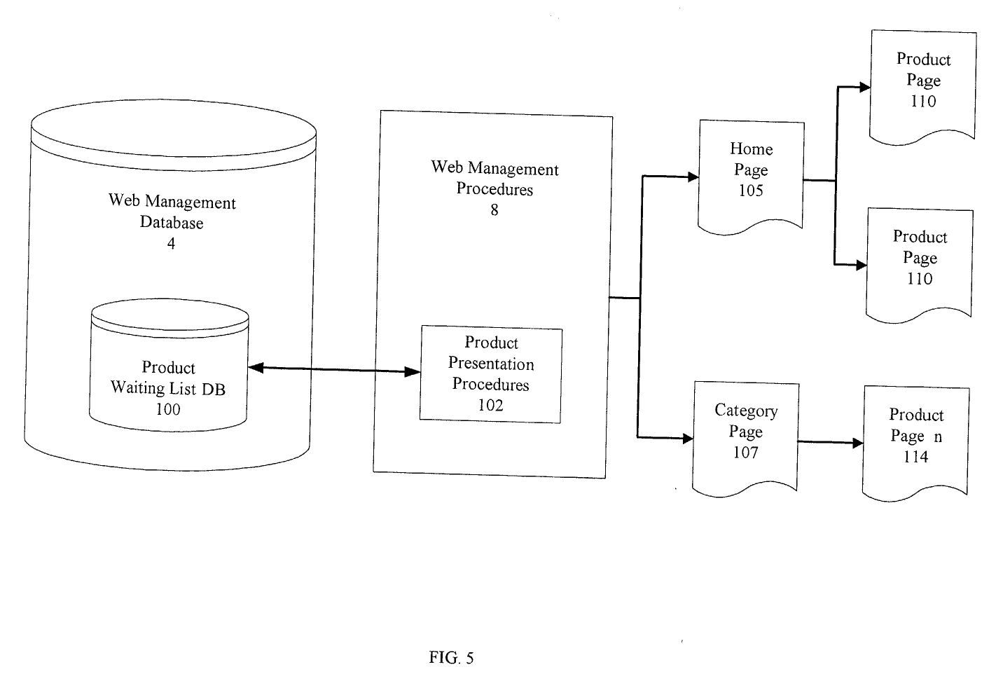

Referring now to FIG. 5, in some embodiments web management database 4 may have a product waiting list database 100 integrated therein, where waiting list database 100 may be a logical part of web database 4. Web management procedures 8 may have product presentation procedures 102 integrated therein, where procedures 102 may be a logical part of procedures 8.

Database 100 may include information regarding all of the products that are in stock and available for purchase via the purchasing system. As discussed above, when a user selects a particular product that product may be removed from the homepage leaving a void for another product to fill. Once a position on the homepage or on particular page is available, an available product is displayed on the general homepage for all users to view. In some embodiments, the new product may be viewed on homepage 105, the product pages 110, 110n and on a category page 107. Category page 107 may display multiple products of the same technology for example, cell phones. Additionally, homepage 105, as well as category page 107, may have multiple products displayed at one time. When a product is purchased homepage 105 and category page 107 may be automatically updated with a new product.

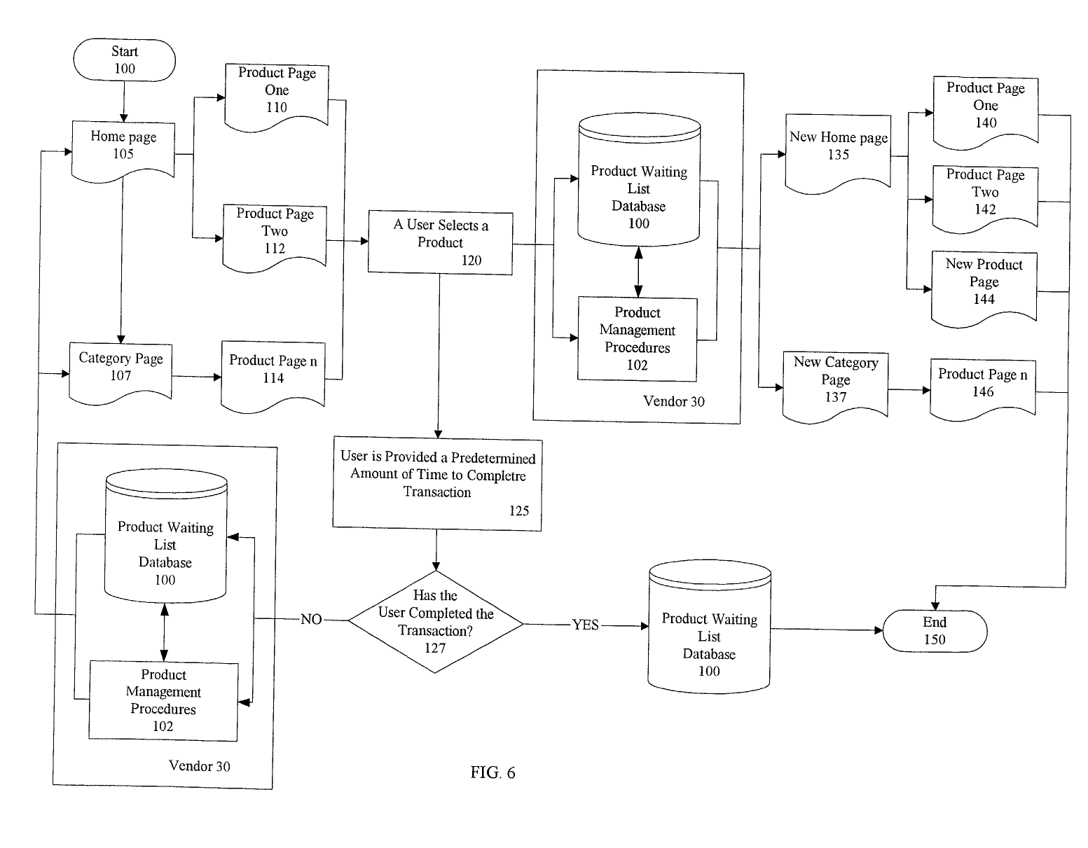

Referring to FIG. 6, user may access the system at start 100 via homepage 105 which may lead to various product pages one, two, etc. 112 or a category page 107. Category page 107 may lead to product pages 114n, which may contain products of similar technologies, for example, mobile telephones. User may select a product to purchase 120 from any of the previously mentioned pages where the user may then be provided with a predetermined amount of time to complete the purchasing transaction 125.

Vendor 30 may have product waiting list 100 and product management procedures 102 located on site, which may control the presentation of new products on new homepage 135 and new category page 137, as discussed in conjunction with FIG. 5 above. If the user does not complete the transaction, product waiting list 100 and product management procedures 102 may implement procedures to place the selected product onto a new version of homepage 105 as discussed above. If the user completes the transaction the product waiting list database may be updated and traditional delivery protocol information may be sent to databases 2 and 4 in order to have the purchased product delivered to the user's previously provided address.

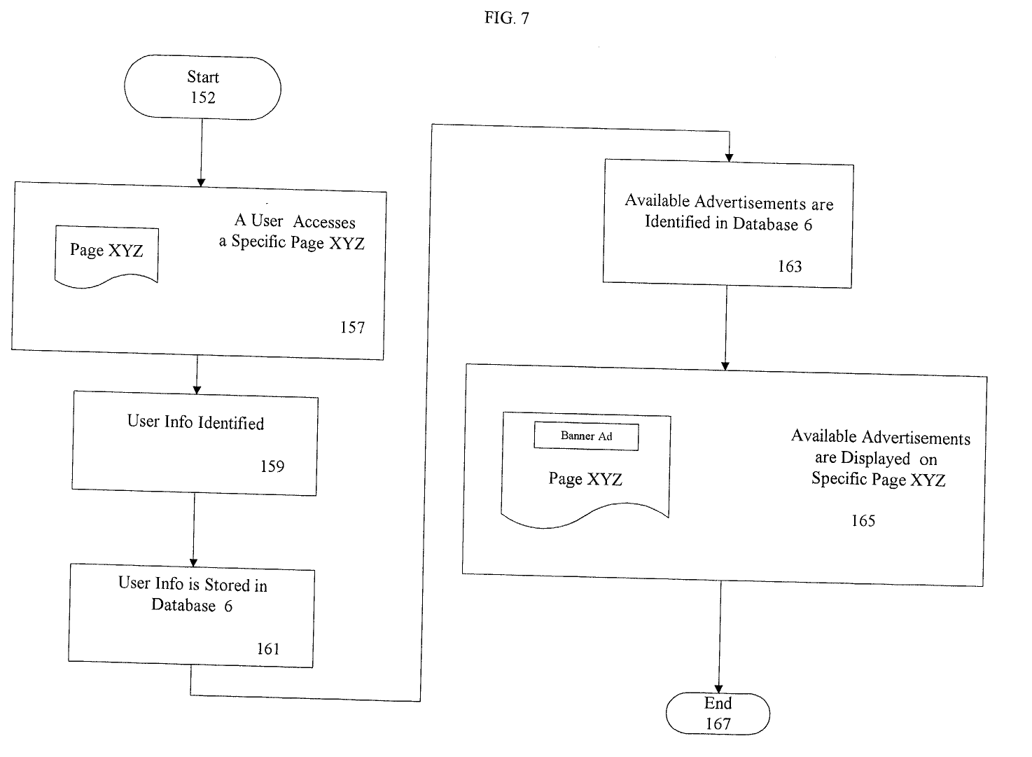

Referring to FIG. 7, user may accesses the system at step 152 via access to specific page XYZ 157, where user information 159 may be identified and updated information regarding the user 161 may be stored in database 6. Advertisement banners available in database 6 may be located and displayed on Page XYZ 165 for viewing by the user. Alternatively, a pre-selected banner may be displayed for viewing by all users depending upon the advertiser, the selected product and other business related factors. In some embodiments, selected advertisements may be displayed as short movies, videos, or voice or text messages depending on the channel through which the user accesses the system.

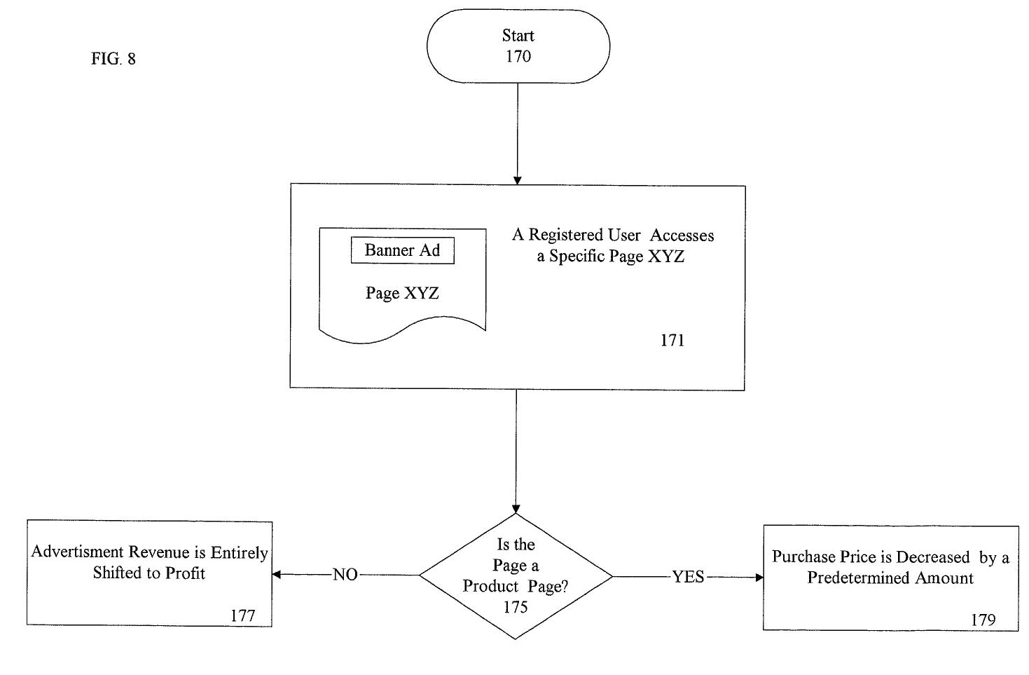

Referring to FIG. 8, a registered user may access specific page XYZ 171 having an advertisement banner displayed thereon. It may be determined whether page XYZ is a product page 175 and if so, the purchase price of the selected product on page XYZ may be reduced by a predetermined amount. If page XYZ is not a product page then the advertising banner revenue may be entirely shifted to profit 177 for vendor 30.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

What is claimed is:

1. A method, comprising the steps of:
displaying an offer for sale of at least one product at a predetermined price, and an advertisement for a product, a seller of the advertised product paying an advertising fee to a party offering the product; and
if the offer is not accepted, offering for sale the at least one product at a price reduced by a portion of the advertising fee.

2. The method according to claim 1, further comprising the step of reducing the price by a predetermined amount based upon a cumulative number of advertisements viewed by at least one user.

3. The method according to claim 2, further comprising the step of determining the amount of advertisements viewed by at least one of the plurality of users.

4. The method according to claim 3, further comprising the step of displaying the advertisement as banner on a web page.

5. The method according to claim 3, further comprising the step of displaying the advertisement in an email message format.

6. The method according to claim 3, further comprising the step of displaying the advertisement as a message sent from a short message service.

7. The method according to claim 3, further comprising the step of displaying the advertisement in a text format.

8. The method according to claim 3, further comprising the step of displaying the advertisement in a video format.

9. The method according to claim 3, further comprising the step of displaying an advertisement for a product unrelated to the product being offered for sale.

10. A method, comprising the steps of:
displaying an offer for sale of at least one product at a predetermined price on a web page to a plurality of users;
displaying an advertisement for a product to the plurality of users;
decreasing the predetermined price for the at least one selected product by a predetermined reduction amount to a decreased purchase price, where the predetermined reduction amount is dependent upon a number of advertisements viewed by the plurality of users.

11. The method according to claim 10, further comprising the step of displaying an advertisement banner on a web page.

12. The method according to claim 11, where the advertisement banner is displayed on the same web page as the selected product.

13. The method according to claim 12, further comprising the step of determining the amount of advertisements viewed by at least one of the plurality of users.

14. The method according to claim 12, further comprising the step of locating the advertisement for the product in a database that stores available advertisement.

15. The method according to claim 14, further comprising the step of selecting an available advertisement banner customized for at least one of the plurality of users.

16. The method according to claim 15, wherein the step of decreasing the predetermined price for the product further comprises the step of storing the decreased purchase price in a database.

17. The method according to claim 14, further comprising the step of displaying the decreased purchase price to the plurality of users.

18. The method according to claim 12, further comprising the step of determining whether each one of the plurality of users are registered users, and where an individual one of the plurality of users is determined to be a registered user, allowing the registered user to purchase the selected product at the decreased price.

19. The method according to claim 18, wherein a plurality of offers for sale of multiple product or services are displayed on the web page.

20. The method according to claim 19, wherein the predetermined price has a set minimum, below which the predetermined price cannot be reduced.

21. The method according to claim 19, wherein the price is reduced at a variable rate dependent upon a cumulative amount of the advertisement banners viewed.

22. A method of selling a product at a reduced purchase price via and with the support of an electronically connected network, such as the Internet, the method comprising the steps of:
displaying at least one offer for sale for at least one individual product at a predetermined price on a vendor web page accessed by at least one user, the web page having at least one advertising banner for which the vendor receives an advertising fee;
determining a cumulative amount of impressions of the at least one advertising banner viewed by the at least one user; and
reducing the price of the at least one individual product by a portion of the advertising fee.

23. The method according to claim 12, further comprising the step of determining whether user is registered, and where user is determined to be registered, allowing the user to purchase the product at the decreased price.

24. The method according to claim 23, wherein the advertising fee is determined from the cumulative amount of impressions viewed by the at least one user.

25. The method according to claim 24, further comprising the step of locating the advertisement banner for the unrelated product in a database that stores available advertisement banners.

26. The method according to claim 25, further comprising the step of selecting an available advertisement banner customized for the at least one user.

27. The method according to claim 26, wherein the step of decreasing the predetermined price for the product further comprises the step of storing the decreased price in a database.

28. The method according to claim 27, further comprising the step of displaying the decreased price to the at least one user.

29. The method according to claim 28, wherein a plurality of offers for sale of multiple products are displayed on the web page.

30. The method according to claim 29, wherein the predetermined price has a set minimum, below which the predetermined price cannot be reduced.

31. The method according to claim 30, wherein the price is reduced at a variable rate for impressions of the advertisement banner viewed.

32. A computer programmed to:
reduce a purchase price of a product offered for sale and displayed on a web page displaying an advertisement by a predetermined amount dependent upon a number of advertisements viewed by at least one user.

33. The computer according to claim 32, wherein the predetermined amount is determined at least in part on an original purchase price, an agreed upon formula in a contract governing fees for the advertisement and local law.

34. A method comprising the steps of:
displaying a first offer for sale of a product at an first purchase price and at least one advertisement;
determining a number of advertisements viewed by at least one user;
generating real time revenue from the advertisement being viewed;
applying a portion of the real time revenue towards the first purchase price of the product; and
displaying a second offer for sale of the product at a second purchase price, the second purchase price being lower than the first purchase price.

35. The method according to claim 34, further comprising the step of reducing the price by a predetermined amount based upon a cumulative number of advertisements viewed by at least one user.

36. The method according to claim 35, further comprising the step of determining the amount of advertisements viewed by at least one of the plurality of users.

37. The method according to claim 36, further comprising the step of displaying the advertisement as banner on a web page.

38. The method according to claim 36, further comprising the step of displaying the advertisement in an email message format.

39. The method according to claim 36, further comprising the step of displaying the advertisement as a message sent from a short message service.

40. The method according to claim 36, further comprising the step of displaying the advertisement in a text format.

41. The method according to claim 36, further comprising the step of displaying the advertisement in a video format.

42. The method according to claim 36, further comprising the step of displaying an advertisement for a product unrelated to the product being offered for sale.

43. A method for purchasing products via and with the support of a network accessed by at least one user, the method comprising the steps of:
accessing a web page displaying at least one product offered for sale and at least one advertisement, where the price of the product offered for sale is reduced by an amount proportional to an amount of advertisements viewed by the at least one user;
and
purchasing the product offered for sale from the web page at a price reduced by a predetermined amount based upon the amount of advertisements viewed.
